(19) United States
(12) Patent Application Publication
(10) Pub. No.: US 2003/0041191 A1
(43) Pub. Date: Feb. 27, 2003

(54) Network-enabled and intelligent versatile device (VD)

(76) Inventors: Roger Pinate, Caracas (VE); Antonio Mugica, Boca Raton, FL (US); Roberto Ponticelli, Caracas (VE); Carlos Alonso, Caracas (VE)

Correspondence Address: JEFFREY FURR, 253 N. MAIN STREET, JOHNSTOWN, OH, 43031, US

(21) Appl. No.: 09/682,382

(22) Filed: Aug. 27, 2001

(51) Int. Cl. G06F 13/12; G06F 13/38

(52) U.S. Cl. 710/62

(57) ABSTRACT

This invention presents a novel and highly versatile, network-ready and intelligent controller architecture, called Versatile Device (VD), which may be programmed to perform any task, regardless of complexity, and may be used to control everyday non-network-ready devices across a network. The Versatile device (VD) comprises five fundamental modules, namely, a central processing unit (CPU) module, a memory module, an input/output ports module, a communications module and a network adapter module. Its open architecture allows it to interoperate across any network, regardless of the underlying networking technology. In addition, such device comprises processing capabilities based on an open processing architecture that is independent of the processing technology used.

### CROSS REFERENCE TO RELATED APPLICATIONS

This invention uses methods and paradigms of true distributed control and distributed logic of our co-pending U.S. patent application No. 09/682059; control cells and tissue of our co-pending U.S. patent application No. 09/682067; versatile controller of our co-pending U.S. patent application No. 09/682092; and smart internetworking operating system of our co-pending U.S. patent application No. 09/682086.

### BACKGROUND OF INVENTION

1. Backgroundfield of the Invention

This invention relates to electronic devices, specifically to an architecture for intelligent and network-enabled versatile devices that can perform a computational task, can openly communicate across a network, and can control other peripheral devices.

2. Backgrounddiscussion of Prior Art

In the present disclosure, the term “device” specifically refers to a unit comprising a combination of software or/and hardware that possesses configurable attributes and parameters that may uniquely identify and distinguish it from other units. The set of configurable attributes and parameters, in some cases, may include a program or application, which describes the operation of the device under all functional circumstances.

A device may be as simple as an electric door lock, or as complex as a composite controller that executes sensitive measurements within a petrochemical industrial process.

This disclosure considers five types of devices, depending on their characteristics and operation: —Dumb device: refers to devices that lack intrinsic intelligence and cannot communicate with other devices. Dumb devices include conventional household appliances, electric lights, among others. In general, these devices only comprise two states of operation, namely, ON and OFF.

Intelligent Device: refers to devices that possess inherent intelligence, or devices that have some processing power and are capable of performing logic functions. Typical intelligent devices include programmable microwave ovens, ABS brakes and traffic lights, among others. - Communication-enabled device: refers to devices capable of transmitting information over a simple communication medium, such as serial or parallel ports. Communication-enabled devices include controllers in master/slave control architectures, Ademco IR detectors, etc.

Network-enabled device: refers to devices fully capable of communicating with other devices across a network, such as an Ethernet network. A personal computer is a common example of network-enabled devices. These are also called network-ready devices.

Smart device: refers to a device that is at once intelligent and network-enabled.

Further definitions are relevant to this disclosure, including those of device networks and device network applications.

In the present disclosure, “device network” refers to a collection of devices interconnected in a networking fashion in which they can communicate with one another to share information and resources, and cooperate to achieve a common task. A device network may contain interconnected devices that belong to any of the device types described above, including network-ready and smart devices. A device network is the underlying physical structure that supports a device network application, and its complexity, in general, depends on the complexity of the implemented application.

The term “device network application” refers to a combination of a software application and an underlying device network infrastructure that comprise a task or process that is to be accomplished or handled. In a device network application, a software application makes use of a physical device network to accomplish this task. Some applications may involve interaction with an end-user (which is done using an application user interface), while some may not involve human interaction at all.

A healthcare/hospital automation system is an exemplary device network application. It comprises a set of devices interconnected to form a device network. These devices include environment-related devices (such as electric doors, electric lights, air conditioners, thermostats, etc) and health-related devices (such as blood pressure monitoring devices, blood sugar monitoring devices, CAT scans, intravenous drug/nutrition dispensers, etc), and others.

A healthcare/hospital automation application controls all these devices to perform according to a set plan. For instance, a siren is activated when an alarmed electric door is opened; electric lights are automatically switched on/off when you walk into or out of a room; after surgery a patient is connected to a heart-monitoring device that continuously checks cardiac rhythm and lets doctors know remotely of the event and/or automatically injects suitable medication to regulate heart function.

A healthcare/hospital automation system involves interaction with a user (i.e., end-user), who can perform device activations (e.g., turn lights on/off) or can perform system configuration. The collection of interconnected devices form a device network while the plan according to which these must perform is a device network application.

The above exemplary automation system assumes that devices on the device network may freely communicate among themselves over a network to carry out the application, i.e., enabling devices to send messages to other devices and receive messages from other devices in such a fashion as to achieve the common task. Yet, most of today”s device technology comprises only dumb or communication-enabled devices. Since dumb or communication-enabled devices cannot communicate across a network, nor be controlled through means other than human interaction (i.e., through manual ON/OFF switches, etc), they need to be connected to network-ready, intelligent devices that may perform remote readings or activations on them. Remote reading involves knowing about a device”s operation state over a network. Remote activations include switching a device ON or OFF, or performing any other type of device function (i.e., control and management) that affects the operation state and parameters of a device.

In the past several years, efforts have been devoted towards developing new device technologies that permit device-to-device communications and interactions. The objective of these has been to interconnect devices to form device networks. Nonetheless, in virtually all cases the results have been limited to proprietary device technologies, including the use of proprietary microprocessors or microcontrollers, or limited to proprietary communication protocols or networking technology.

Open inter-device communication and independence of both proprietary networking and proprietary processing technologies are essential to the construction of complete device networks that are fully scalable and fit for mass-market applications. There is a real need for an open smart device architecture that has a plug-and-play nature that permits easy implementation of existing technologies and easy adaptation to upcoming technologies, and that is highly compatible and highly versatile to be useful for any type of application, regardless of application type (e.g., single device applications, multi-device applications, distributed applications, etc).

In view of the limitations of the art, the present invention describes an innovative device architecture that can be used to produce highly versatile smart devices that can communicate openly across a network, regardless of network protocol and/or medium. In addition, said architecture can comprise any kind of processing technology, and can serve as a transparent bridge that can be used to control dumb, communication-enabled or otherwise non-network-ready devices across a network. Such device can be used to implement any type of task or application, regardless of complexity.

### SUMMARY OF INVENTION

This invention presents a novel and highly versatile, network-ready and intelligent controller architecture, called Versatile Device (VD), which may be programmed to perform any task, regardless of complexity, and may be used to control everyday non-network-ready devices across a network. Its open architecture allows it to interoperate across any network, regardless of the underlying networking technology. In addition, such device comprises processing capabilities based on an open processing architecture that is independent of the processing technology used.

### OBJECTS AND ADVANTAGES

Accordingly, several objects and advantages of the present invention are:

a)To present an innovative device architecture that comprises open processing and networking capabilities whose versatility permits the implementation of any type of smart device networks and applications, regardless of complexity;

b)To present an innovative device architecture that produces devices that are fully network-ready and are not bound to any proprietary or specific networking technology, but is capable of supporting all networking protocols and/or media;

c)To present an innovative device architecture that results in intelligent devices that can be programmed to perform a task, regardless of complexity, and is not bound to any proprietary or specific processing technology;

d)To present an innovative device architecture that comprises means to communicate with and/or control conventional, dumb, communication-enabled, or otherwise non-network-ready devices, and can thus be used to create smart device networks comprising conventional devices.

Other objects and advantages of this invention will become apparent from a consideration of the ensuing description and drawings.

### BRIEF DESCRIPTION OF DRAWINGS

FIG. 1 illustrates details of the Versatile Device (VD) architecture described in the present invention.

FIG. 2 illustrates a typical device network according to the present invention.

FIG. 3 illustrates details of the Versatile Device of the present invention, and how dumb or otherwise non-network-ready peripheral devices may be connected to them.

### LIST OF REFERENCE NUMERALS IN DRAWINGS

1 Versatile device (VD)

2 VD”s CPU module

4 VD”s memory module

6 VD”s input & output ports module

8 VD”s communications module

10 VD”s network adapter module

12 Router interconnecting Type III and Type II networks

20 Type III wireless network

22, 37 Type II network

24 Type I network

28, 30 VDs connected to Type III network

32 Router interconnecting Type Ill and Type II networks

34, 36, 38, 40 VDs connected to Type II network

42, 43, 44 VDs connected to Type I network

46 Router interconnecting Type I and Type II networks

100, 11 8 VDsl 02 to 108 Non-network-ready devices connected to VD 100

110 to 116 Non-network-ready devices connected to VD 118

### DETAILED DESCRIPTION

The architecture herein disclosed will now be described by referring to the accompanying drawings that illustrate the preferred embodiment of the invention.

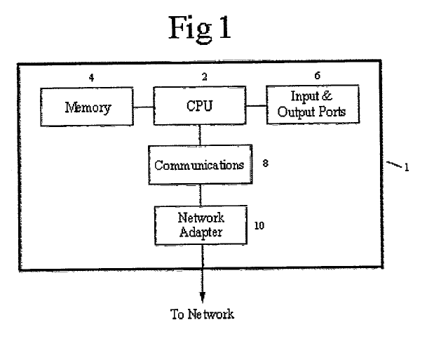

FIG. 1 illustrates the internal structure of the smart device architecture presented in this invention. Versatile device (VD) 1 comprises five fundamental modules, namely, a central processing unit (CPU) module 2, a memory module 4, an input/output ports module 6, a communications module 8 and a network adapter module 10.

The CPU, as the name implies, is the central processing brain of the VD. It performs general control of all VD resources, including the management of all other modules on the device, such as the memory and the communication modules. In general, the CPU 2 is a microprocessor whose processing capabilities depend on the complexity of the application for which it is intended. Nonetheless, low processing power microprocessors are preferred (specifically 8-bit microprocessors, such as PIC17C756) due to the relatively lower cost they entail, which facilitates the production of low-cost smart devices. The CPU 2 is directly connected to the memory module, the input/output ports module and the communications module.

The memory module 4, as the name implies, is the device component that stores all data that is manipulated by the CPU, including processing data, program data and variables; resource state and usage; communication data, states and variables; all in all, it may contain all information that is required for successful VD operation. The memory module may comprise any standard volatile and non-volatile memory chips (e.g., DS1248Y), and its size and resources depend on the memory requirements of the application and the network on which the device will operate. In some implementations, the memory contains within the CPU 2 may be sufficient (in case the microprocessor that implements CPU 2 comprises internal memory resources).

However, in the preferred embodiment the memory module is an external component that is physically independent from the CPU.

The input and output ports module 6 is a generic unit that may contain several simple communication ports of different types, including input-only, output-only, dual input/output or relay ports. These ports can be used by the VD to perform simple control, communications and interaction with external peripheral devices, such as controlling the state of non-network-ready or otherwise dumb peripheral devices. Peripheral devices may be either digital or analog sensors and actuators, and may be any type of conventional device, such as electric door locks, air conditioners, car engines, elevators and heart monitoring devices, among several others.

The communications module 8 is responsible for basic communications between the VD”s internal modules (e.g., CPU 2) and the outside world (e.g., a device network). It comprises two primary abstract functions, namely, Send and Receive. The communications module creates an abstraction layer that allows the VD to operate independently of the underlying networking technology used to connect it to a network and to other devices, whether VD or non-VD.

Network adapter module 10 is the interface that permits the connection of the VD to any type of network. Network adapters 10 are of a plug-and-play nature. In one implementation, there is one such network adapter for every supported network type. However, a single network adapter module may be used to connect a single VD to many networks of different types. When a VD is to be connected to an Ethernet network, an Ethernet network adapter must be plugged into the VD; if, later, the same VD is to be connected to a LonTalk network, the Ethernet network adapter must be unplugged and a LonTalk network adapter must be plugged in. However, it is sometimes possible to build a network adapter module that detects the type of network it is connected to, and sends and receives messages accordingly in the appropriate protocol and physical protocol. Given the plug-and-play architecture described herein, this process requires no modifications to VD hardware other than plugging in an appropriate module. The network adapter module connects on one side to the VD”s communications module and on the other side to the device network. Thus, the network adapter module 10 is said to connect and interface the VD with the network.

As shown on FIG. 1, in the preferred embodiment the CPU is connected to the memory module, the input/output ports module and the communications module. The memory module is solely connected to the CPU module. The input/output ports module is solely connected to the CPU module. The communications module connects to the CPU module on one side and to the network adapter module on the other side. The network adapter module is connected to the communications module on one side and to the device network on the other side.

### Operation of Invention

As shown on FIG. 1, a VD”s CPU is connected to its memory module, the input/output (I/O) ports module and the communications module. Hence, these three modules operate independently of each other and depend on the CPU for their operation. The network adapter, in turn, is independent of the above three modules (CPU, memory, I/O) and interacts exclusively with the communications module.

The CPU module of a VD is itself processing hardware (i.e., a microprocessorbased unit) that requires a program that specifies its operation, e.g., how it should manage all other resources present on the device, how it should react to messages received from the network, what messages it should send out to the network, and many other operation aspects.

The CPU module thus is dependent on the programs or applications that are copied onto its program memory, which can reside within the CPU (e.g., in the form of processor cache memory) or in the memory module. Programs or applications determine the actions that the CPU will take towards accomplishing a task. The present invention, in the preferred embodiment, involves the smart internetworking operating system (SIOS) of our co-pending U.S. patent application No. 09/682086, and in fact provides the ideal architecture that SIOS can use to exploit its advantages. Other suitable real-time and multitasking operating systems for low processing power microprocessors may be used, as long as they pose no limitations to the applicability of the present invention. The operating system handles requests from multiple applications and responds to them in real-time, maximizing usage of resources present in the device, including interaction with memory, input/output ports and communications modules. A VD can also operate without an underlying operating system; just following the program downloaded onto it in the form of program code instructions (e.g., microcode).

The memory module stores all data necessary for successful accomplishment of VD tasks, including program memory (e.g., application or operating system instructions), variables, operation contexts, and any other information that is used by application and/or the operating system processes (as applicable) that execute on the CPU. The memory module interacts exclusively with the CPU, and its operations include basic memory read/write operations performed by CPU processes and other operations.

The input and output (I/O) ports modules involve the connection of external peripheral modules to the VD. Ports can be input-only (for peripheral devices that transmit information into the VD), output-only (for peripheral devices that receive information from the VD), dual input/output ports (for peripheral devices that may both exchange information with a VD over a basic medium), and relay ports (for peripheral devices that have two operating states, ON/OFF). External peripheral devices may be dumb or communication enabled peripheral devices that are not capable of communication with other devices across a network (i.e., not-networkready devices).

Through I/O ports, basic signals are sent to and received from peripheral devices by electrical, optical or other means. A peripheral device that has an associated output signal can be connected to a VD”s input-only port. For instance, ionic smoke detectors comprise a signal (either high line or low line) that indicates the state of the smoke detector. This signal is normally at low line (digital 0, e.g., 0 Volts). When a fire occurs, it is raised to high line (digital 1, e.g., 5 Volts). As the smoke detector is connected to the VD”s input-only port, the VD detects a change in the signal from the smoke detector and knows that a fire has been detected.

Peripheral devices that require an input signal may be connected to a VD”s output-only ports. When appropriate, the VD can alter the signal at its output-only port (be it analog or digital), depending on the signal that the peripheral device requires. For instance, some video cameras can be turned ON/OFF (or otherwise manipulated) using a digital signal. If the video camera is connected to an output-only port, the VD can control the video camera, turn it ON/OFF or otherwise manipulate its state or parameters by varying the signal at its output-only port.

Peripheral devices that are capable of sending and receiving basic signals over a basic medium can be connected to a VD”s dual input/output ports. This is the case with some communication-enabled devices, such as proximity card readers. These devices transmit information into a VD and receive responses from it, or vice versa. In one implementation, dual input/output ports use the serial communications protocol to interact with peripheral devices. In general, however, I/O-based interaction in dual ports is accomplished through simpler protocols or methods.

Other ports in this module include relay ports. Although technically not input/output ports, relay ports can be used to switch dumb peripheral devices ON/OFF, or in any other application where a controllable electrical switch may be required. In general, relays are used (i.e., opened or closed) to connect dumb devices that have two fundamental operational states (ON/OFF) to a VD. In general, when relays are closed the peripheral device is turned ON. Otherwise, the device is OFF. Examples of peripheral devices connected to relays are electric lights and electric door locks.

In some instances, a specialized peripheral device may be connected to a dual input/output port and work as an extension of the input/output ports module of a VD, expanding the resources available in this module, such as creating additional high-speed ports to connect high-speed sensors, or other devices not conventionally connected to the invention. In one implementation, a specialized peripheral device (called a I/O port expander) was connected to a dual I/O port using the IIC protocol.

The input/output ports module may be implemented within the CPU, as a processing task. However, this may not be desired in some instances, when special output signals or voltages are required. In those cases, this module may be assisted by an external CPU-controlled signal generator.

The operation of the communications and network adapter modules depend on one another. The communications module acts as an abstraction layer, logically separating internal data and communication structures from data and communication structures used by the networking technology in the device network. Thus, each VD internally uses two primary routines in its communications module, namely, Send and Receive. When a VD process needs to send a message to the device network, its CPU may call on the communications module”s Send operation with the VD”s internal communications data structure that is to be sent. Whenever a Send operation is issued, the communications module receives the data to be sent and interfaces with the network adapter currently in place. The network adapter, in turn, translates the device”s internal data and communication structures onto network-specific data and communications structures.

When data is received from the device network through the network adapter, the VD”s CPU will call on the communications module”s Receive operation to retrieve data that has been received. The communications module will interface with the network adapter module in place, translate the received information into VD internal data and communication structures, and pass the data to the CPU for further processing.

The network adapter is, in general, an external peripheral device whose hardware depends on the type of network with which it has been designed to interface. The logical separation of the communications module and the network adapter permits that the internal operation of the VD be completely independent of the underlying networking technology. When a VD is to be connected to a network, a networkspecific adapter is connected to it. In no case will the communications module need to be modified, as it handles VD internal structures, which are network-independent.

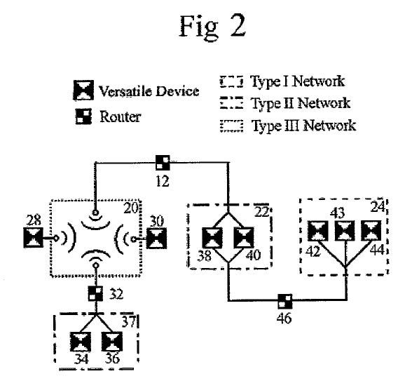

FIG. 2 illustrates a typical device network configuration for the present invention. It comprises an exemplary hybrid device network in which a plurality of networks 20, 22, 24 and 37, interconnected by routers 1 2, 32 and 46. Said routers serve as connection links between any two networks of different network type, such as between networks 20 and 22, which may use dissimilar communication protocols and/or media. In FIG. 2, network 20 is of Type III, network 22 and 37 are of Type II, and network 24 is of Type I. Network Type I, II or III are arbitrary and hypothetical network types, e.g., Ethernet, CDPD, ATM, etc.

Each said network contains a plurality of VDs. For instance, network 20 comprises VDs 28 and 30; network 22 comprises VDs 38 and 40; network 24 comprises VDs 42, 43 and 44; and network 37 comprises VDs 34 and 36.

As explained above each interconnected VD comprises identical CPU, input/output ports, memory and communications modules. In addition, each VD comprises a network adapter module of a type corresponding to the network (e.g., protocol and medium) to which it is connected. That is, VD 28 and 30 comprise a network adapter module corresponding to network type III, etc.

As VDs are fully capable of sending information across a network, VDs connected to any network on FIG. 2 can send messages to any other VD to share information and resources, or to cooperate as part of a device network application to achieve a common task.

A VD”s CPU provides it with processing capabilities to perform tasks that involve computational operations as well as control of all device resources, including memory, communications and input/output ports. A VD”s memory module stores all data related to its operation.

A VD”s input/output ports offer capabilities that allow connection of multiple types of communication-enabled or dumb peripheral devices to a VD. After peripheral devices have been connected to a VD, the VD”s CPU will be able to control their state and operation parameters. The I/O ports module of every VD may or may not be the same, as required by the application (e.g., some VDs may need to have more peripheral devices, etc). In general, however, all VDs comprise identical I/O ports modules, which reduces VD production costs.

VD”s communications module provides complete communication capabilities that have been abstracted from networking technology-specific issues. These capabilities enable each VD to communicate openly with any other device (be it a VD or other) that exists on the network to which it is connected. Thus, the communications modules of all VDs on FIG. 2 are identical.

Finally, a VD”s network adapter module receives messages from the VD”s communications module and translates them to network-specific data, and actually handles data transport, network, data-link and physical transmission issues, as necessary. All network adapter modules of VDs that reside in networks of same type may be identical.

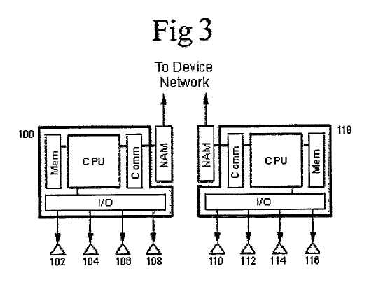

FIG. 3 illustrates two VDs 100 and 118 interconnected by a device network. Each of said VDs comprises a collection of peripheral devices connected to it, through their respective input/output ports modules. It also shows the way in which dumb devices are connected to each VD. VD 100 comprises several dumb and/or communicationenabled devices 102 to 108 connected to it. VD 118 comprises several dumb and/or communication-enabled devices 110 to 116 connected to it. Every peripheral device thus is connected to one and only one VD. Examples of peripheral devices (102 to 116) connected to a network end node are electric door locks, push buttons, air conditioners, TVs, car engines, surveillance cameras, industrial controllers, and any other type of non-network-ready devices.

Following the description and operation of VDs and network-interconnected VDs, VDs are highly versatile devices. They can handle one or more applications simultaneously, depending on the program structure and functioning that is downloaded onto them. VDs have been designed with a highly open and generic architecture that is the ideal generic device architecture to be used by the Smart Internetworking Operating System (see our co-pending U.S. patent application Ser. No. 09/682086). Device applications, as mentioned above and as permitted by SIOS capabilities, can involve not only one, but also two or more devices. A simple device network application can be divided into processes, each of which exists in a specific VD”s CPU and memory. Each VD acts according to the code downloaded onto it, which specify a set of action rules that the VD must follow depending on circumstances. For example, a VD can be programmed to execute a task in response to a message received from another VD on the network. The result of its processing may cause a message to be sent to a third VD. When the third VD receives the message, it starts execution of a further process, and so on. As all VDs can openly communicate with themselves, and as applications are divided into processes and downloaded into specific VDs for processing, a device network based on VDs can readily serve to implement a true distributed control system (see True Distributed Control of our copending U.S. patent application Ser. No. 09/682059). The set of rules that governs the behavior of VDs under any operational circumstances is termed distributed logic, in said co-pending application.

Further, considering that every single device on the network may actually be of identical physical characteristics (i.e., all contain equivalent CPU, memory, I/O ports and communications modules), and according to the VD”s description and operation provided above, it follows that VDs are highly versatile devices that can be used to implement the paradigm of versatile controllers (see our co-pending U.S. patent application Ser. No. 09/682092), and can be used as control cells to implement control tissue, organs, etc., which can implement any application, distributed or not, regardless of complexity (see our co-pending U.S. patent application Ser. No. 09/682067). The disclosed VD architecture exploits the concept of versatility, versatile controller, and single-cell control of our co-pending application and discloses one possible implementation.

CONCLUSION, RAMIFICATIONS AND SCOPE OF INVENTIONThus, the reader will see that the presented invention provides an innovative device architecture that comprises open processing and networking capabilities whose versatility permits the implementation of any type of smart device networks and applications, regardless of complexity. VDs are fully network-ready devices and are not bound to any proprietary or specific networking technology, but are capable of supporting all networking protocols and/or media. VDs are intelligent devices that can be programmed to perform a task, regardless of complexity, and are not bound to any proprietary or specific processing technology. Finally, VDs comprise means to communicate with and/or control conventional, dumb, communication-enabled, or otherwise nonnetwork-ready devices, and can thus be used to create smart device networks comprising conventional devices.

While our above description contains many details, these should not be construed as limitations to the scope of the invention, but rather as an exemplification of one preferred embodiment thereof. Obviously, modifications and alterations will occur to others upon a reading of this specification. For example, VDs do not require an operating system to operate, as they can function based on traditional program code (e.g., microprocessor-specific microcode) that is downloaded onto it. In addition, a single, multipurpose network adapter may be used to connect a VD concurrently to two or more networks of different types, if deemed appropriate. A peripheral device may be connected to more than one VD to provide a higher level of reliability. A VD can interact with other network-ready and non-network-ready devices (i.e., non-VD devices) to exchange information as long as the other devices have some means of communications. Non-VD devices can be connected to a VD across a network, or through I/O ports modules. There are no limitations as to the internal structure and operation of the many modules within a VD. For instance, a VD”s CPU may comprise more than one microprocessor, if need be, if a higher level of local processing power is required.

Further, network communications can include encryption/decryption of network messages to ensure that sensitive information that travels between VDs or between VDs and other devices cannot be obtained by alien entities or eavesdroppers. Likewise, strong authentication can be included before starting communications between any two devices (or every time a network message is received) to avoid foreign, unwanted devices to interfere and/or information into VDs and the VD network. Both encryption and authentication processes may be carried out at the CPU level, using the CPU module”s processing power. In the preferred embodiment, however, encryption and authentication are carried out by the network-specific network adapter module, or as a combined process between the CPU and the communications and network-adapter modules. In this case, authentication may be carried out by the network adapter, as it may involve some network-specific processes. After successful authentication, encrypted data is then passed from the network adapter to the communications module and then to the CPU, which can decrypt it before further processing.

One may see that two VDs can be connected to each other, if need be, without the use of network adapters, provided the internal data structures of every VD involved are equivalent. This may be beneficial under some circumstances and for some applications. In the preferred embodiment, however, the use of a network adapter is fundamental so as to exploit the capabilities of existing networking technologies and to be able to interconnect VDs that reside in geographically distant locations.

Finally, in some instances, it may be desired that the communications module possesses some internal processing module that handles sending and receiving of messages. In these cases, the CPU does not have to invest processing cycles to control sending and receiving of messages (i.e., the Send/Receive operations described above). The CPU is thus relieved of that responsibility and can invest those processing cycles in other processes.

The description above is intended, however, to include all such modifications and alterations insofar as they come within the scope of the appended claims or the equivalents thereof.

What is claimed is:

1. A highly versatile, network-ready and intelligent controller architecture devices, the devices comprising:
a. a processing means;
b. a memory means;
c. an input/output ports means;
d. a communications means; and
e. a network adapter means.

2. The device of claim 1 wherein the processing means is a low power microprocessor.

3. The device of claim 1 wherein the memory means is physically independent from the processing means.

4. The device of claim 1 wherein the input/output means consists of a plurality of communication ports from a choice of input-only, output-only dual input/output or relay ports.

5. The device of claim 1 wherein the communication means comprises two functions, send and receive.

6. The device of claim 1 wherein the communication means creates an abstraction layer that logically separates internal device operation from the network.

7. The device of claim 1 wherein there is a Network Adapter means for each network type supported.

8. The device of claim 1 wherein the Network Adapter means can detect the type of network it is connected to and sends and receives messages accordingly in the appropriate protocol and physical protocol, and is capable of data encryption for secure communications.

9. The device of claim 1 wherein the Network Adapter means connects the communications means and the network.

10. The device of claim 1 wherein the processing means is connected to the memory means, the input/output means and the communications means with the network adapter means interacting with the communication means.

11. The device of claim 1 wherein the smart internetworking operating system is used.

12. The device of claim 1 wherein an internetworking operating system is used.

13. The device of claim 1 wherein the device interacts with other devices to form a true distributed control system.

14. The device of claim 1 wherein the device is used as a versatile controller for any application, regardless of type.

15. A method for creating a novel and highly versatile, controller architecture using devices comprising of:
a. a processing means;
b. a memory means;
c. an input/output ports means;
d. a communications means; and
e. a network adapter means.

16. The method of claim 15 wherein the processing means is a low power microprocessor.

17. The method of claim 15 wherein the memory means is physically independent from the processing means.

18. The method of claim 15 wherein the input/output means consists of a plurality of communication ports from a choice of input-only, output-only dual input/output or relay ports.

19. The method of claim 15 wherein the communication means comprises two functions, send and receive.

20. The method of claim 15 wherein the communication means creates an abstraction layer that logically separates the internal device operation from the network.

21. The method of claim 15 wherein there is a Network Adapter means for each network type supported.

22. The method of claim 15 wherein the Network Adapter means detects the type of network it is connected to and sends and receives messages accordingly in the appropriate protocol and physical protocol, and is capable of data encryption for secure communications.

23. The method of claim 15 wherein the Network Adapter means connects the communications means and the network.

24. The method of claim 15 wherein the processing means is connected to the memory means, the input/output means and the communications means with the network adapter means interacting with the communication means.

25. The method of claim 15 wherein an operating system is used.

26. The method of claim 15 wherein the smart internetworking operating system.

27. The method of claim 15 wherein the device interacts with other devices forming a true distributed control system.

28. The method of claim 15 wherein the device is used as versatile controller for any application, regardless of type.
